(19) United States
(12) Patent Application Publication
(10) Pub. No.: US 2015/0143004 A1
(43) Pub. Date: May 21, 2015

(54) COMMUNICATION APPARATUS, COMMUNICATION SYSTEM, AND COMMUNICATION METHOD

(71) Applicant: Kuniyoshi Shirai, Tokyo (JP)

(72) Inventor: Kuniyoshi Shirai, Tokyo (JP)

(73) Assignee: TOYOTA JIDOSHA KABUSHIKI KAISHA, Toyota-shi, Aichi-ken (JP)

(21) Appl. No.: 14/400,725

(22) PCT Filed: May 15, 2012
(86) PCT No.: PCT/JP2012/062347

§ 371 Date: Nov. 12, 2014

(51) Int. Cl. G06F 13/42; G06F 13/26

(52) U.S. Cl. CPC G06F 13/423; G06F 13/26
USPC 710/105

(57) ABSTRACT

Provided is a communication system that can aim to prevent unauthorized communications, i.e., to improve the reliability of communicated messages. A communication system comprises a plurality of ECUs connected to a communication line such that the plurality of ECUs can communicate communication messages. Each of the plurality of ECUs has a unique ID and also has a plurality of dummy IDs defined, as substitute candidates, from the unique ID. The ECU further has a defined pattern in which to cause one of the plurality of dummy IDs to be selected as a dummy ID that is a substitution object to be converted to the unique ID. Among the plurality of ECUs, the selection conditions of the substitution objects based on the pattern are synchronized, and the unique ID, which has been added to a communication message, is converted to a dummy ID on the basis of the pattern. Further, among the plurality of ECUs, the communication message, to which the dummy ID after the conversion has been added, is transmitted, and the dummy ID, which is acquired from the received communication message, is reconverted to the unique ID on the basis of the pattern. Finally, among the plurality of ECUs, the received communication message is identified on the basis of the unique ID after the reconversion.

### TECHNICAL FIELD

The present invention relates to a communication apparatus that is network-connected in a vehicle or the like, a communication system in which a plurality of communication apparatuses are network-connected, and a communication method.

### BACKGROUND ART

As known in the art, a plurality of electronic control units (ECU) mounted on a vehicle often configure a communication system in which each of the electronic control units is network-connected to each other so that information (vehicle information) of the electronic control units can be communicated between the electronic control units. In other words, such a communication system is configured as a vehicle network system with the ECUs serving as communication apparatuses. Such a vehicle network systems is a controller area network (CAN).

The CAN enables each ECU, which shares a bus or a communication line, to determine to send a message on a bus, and hence a message is easily transmitted from each ECU to the bus. Thus, for example, an unauthorized ECU can be connected to the bus of the CAN and an unauthorized message can be transmitted to the bus. When such an unauthorized message is transmitted, the ECU that receives the message may process the unauthorized message in a manner similar to a normal message.

Accordingly, techniques for preventing communication of an unauthorized message have been proposed in the prior art, one example of which is described in patent document 1.

A communication system described in patent document 1 includes a plurality of communication terminals connected to a network, and each communication terminal includes a transmission/reception unit for transmitting and receiving data to and from another communication terminal. The transmission/reception unit includes a unique information list that stores unique information, which is a value unique to the communication terminal, a network unique value recording means that stores a network unique value, which is a value shared among all the communication terminals, a unique information converting means that converts the unique information of the communication terminal with the network unique value to a converted unique value, and a converted unique information list that stores the converted unique value. The transmission/reception unit includes a transmitting section for transmitting transmission data, to which the converted unique value is added by a frame generating section, as a message, a coinciding determining section for determining whether or not the converted unique value added to the received message coincides with the converted unique value held in the converted unique information list, and a receiving section for receiving the communication data determined as “coinciding” by the coinciding determining section. That is, in the communication terminal, if the converted unique value added to the reception data does not coincide with the converted unique value held in the converted unique information list, the reception data is discarded. Furthermore, the converted unique information is updated when updating the network unique value in the communication system, but the converted unique formation is not correctly updated in a communication terminal changed in an unauthorized manner. Thus, the communication terminal is prevented from being changed in an unauthorized manner, and the network security can be improved.

### PRIOR ART DOCUMENT

### Patent Document

Patent Document 1: Japanese Laid-Open Patent Publication No. 2006-319606

### SUMMARY OF THE INVENTION

In the communication system described in patent document 1, unauthorized and changed communication terminal cannot carry out communication after the network unique value is updated since the communication terminal does not have the converted unique information updated based on the updated network unique value. However, the unauthorized and changed communication terminal can use the converted unique information acquired from the message transmitted through the network until the network unique value is updated. Thus, the communication system may not be able to prevent unauthorized communication with the unauthorized and changed communication terminal when using the converted unique information acquired from the message flowing through the network.

Accordingly, it is an object of the present invention to provide a communication system and a communication method capable of preventing unauthorized communication, that is, improving the reliability of the communicated message, and a communication apparatus used in the communication system.

The means for solving the above problem and the effects thereof will be described below.

To achieve the above object, the present invention provides a communication system that includes a plurality of communication apparatuses connected to a communication line. The communication apparatuses are capable of communicating a communication message. A unique identifier is added to the communication message to identify the communication message. The unique identifier, a plurality of simulated identifiers serving as replacement candidates from the unique identifier, and a pattern for selecting one of the simulated identifiers as a replacement subject that replaces the unique identifier are set for the communication apparatus. A selecting condition of the replacement subject based on the pattern is synchronized in the communication apparatuses. A communication apparatus that transmits the communication message replaces the unique identifier added to the communication message with the simulated identifier based on the pattern, and transmits the communication message to which the simulated identifier is added after the replacement. A communication apparatus receiving the communication message re-replaces a simulated identifier acquired from the received communication message with the unique identifier based on the pattern, and identifies the received communication message based on the re-replaced unique identifier.

To achieve the above object, the present invention provides a communication method in which a plurality of communication apparatuses communicate a message through a communication line. The communication method includes adding a unique identifier to the communication message that is transmitted to identify the communication message, replacing the unique identifier with one simulated identifier selected from a plurality of simulated identifiers replaceable with the unique identifier based on a pattern, synchronizing a selecting condition in the communication apparatuses based on the pattern, and transmitting the communication message after replacing the unique identifier with the simulated identifier.

To achieve the above object, the present invention provides a communication method in which a plurality of communication apparatuses communicate a message through a communication line. The communication method includes the steps of acquiring a simulated identifier from a received communication message, replacing the acquired simulated identifier with a unique identifier used to identify the communication message based on a pattern, synchronizing the replacement in the communication apparatuses based on the pattern, and identifying the communication message based on the unique identifier after the simulated identifier is replaced.

To achieve the above object, the present invention provides a communication apparatus that is connected to a communication line and communicates a communication message with another communication apparatus connected to the communication line. A unique identifier is added to the communication message to identify the communication message. The unique identifier, a plurality of simulated identifiers serving as replacement candidates from the unique identifier, and a pattern for selecting one of the simulated identifiers as a replacement subject that replaces the unique identifier are set for the communication apparatus. A selecting condition of the replacement subject based on the pattern is synchronized in the communication apparatuses. The unique identifier added to a communication message that is transmitted is replaced with the simulated identifier based on the pattern. The communication message to which the simulated identifier is added is transmitted after the replacement.

To achieve the above object, the present invention provides a communication apparatus that is connected to a communication line and communicates a communication message with another communication apparatus connected to the communication line. A unique identifier is added to the communication message to identify the communication message. The unique identifier, a plurality of simulated identifiers serving as replacement candidates from the unique identifier, and a pattern for selecting one of the simulated identifiers as a replacement subject that replaces the unique identifier are set for the communication apparatus. A selecting condition of the replacement subject based on the pattern is synchronized in the communication apparatuses. The simulated identifier added to a received communication message is re-replaced with the unique identifier based on the pattern. The received communication message to which the unique identifier is added is identified after the re-replacement.

According to such a configuration or method, the unique identifier used for the identification of the communication message is replaced by the simulated identifier in the communication with another communication apparatus, and the communication message is transmitted or received by the simulated identifier of after the replacement.

Thus, if the communication of the communication message is carried out based on the simulated identifier, even if the unique identifier is acquired in an unauthorized or inadvertent manner, the communication of the unauthorized communication message based on the unique identifier can be prevented. In other words, the reliability of the communication message communicated by the communication system can be improved.

The simulated identifier that replaces the unique identifier is selected based on the pattern. Thus, the simulated identifier used for the communication can be changed based on the pattern. Therefore, even if the unique identifier or the simulated identifier is acquired in an unauthorized or inadvertent manner, the communication by the unauthorized communication message can be prevented by switching the simulated identifier used in the communication. Furthermore, since the pattern for selecting the simulated identifier is difficult to recognize even when monitoring the communication message, the assumption of the pattern for selecting the simulated identifier appropriate for the communication becomes difficult even if the simulated identifier is acquired. This prevents communication of an unauthorized communication message.

Preferably, the number of simulated identifiers set as the replacement candidate for the unique identifier of the communication message is greater in a communication message having a high priority than a communication message having a low priority.

According to such a configuration, the reliability of the communication message having a high priority is increased. Thus, an appropriate reliability corresponding to the level of priority can be set for the communication message.

Preferably, the selecting condition of the replacement subject based on the synchronized pattern is a condition in which a communication message to which the simulated identifier is added after the replacement is sent to the communication line.

According to such a configuration, an appropriate simulated identifier is selected, that is, updated for each communication using the simulated identifier. Thus, an unauthorized communication message becomes difficult to communicate using the appropriate simulated identifier, and the reliability of the communication message remains high.

Preferably, the pattern is a random pattern of a pseudo random number generated based on the number of times the communication message is sent to the communication line.

According to such a configuration, the replacement subject is selected by the random pattern, and thus it is difficult to appropriately assume the simulated identifier that is selected even if the communication message is being monitored. Thus, unauthorized communication using the simulated identifier becomes difficult, and the reliability of the communication message remains high.

Preferably, the communication apparatuses include a counter that counts the number of times the communication message is sent to the communication line, and the selecting condition of the replacement subject based on the pattern is synchronized based on a measured count value of the counter.

According to such a configuration, the selection of the simulated identifier of the replacement subject can be synchronized among the plurality of communication apparatuses. Thus, the selecting subject is easily and reliably selected in each communication, and the reliability of the communication message remains high.

Preferably, the communication message is a message of a CAN protocol, and the unique identifier is a message ID set in the CAN protocol.

According to such a configuration, the reliability of the communication message based on the CAN protocol can be maintained high. The communication apparatus that received the communication message by the CAN protocol usually processes the message if the message ID given to the communication message is correct. However, according to the configuration, the message ID is set as the simulated identifier, so that the reliability of the communication message can be enhanced.

Preferably, the simulated identifier is selected from unique identifiers that are not added to the communication message.

According to such a configuration, among the identifiers that can be defined as the unique identifier, for example, a non-assigned (vacant) identifier and an ID in which the usage condition is limited such as for testing, for example, can be used. Thus, the communication system that improves the reliability of the communication message may easily be applied to an existing system.

Preferably, a plurality of identifiers that are continuous with the unique identifier are set as the simulated identifiers.

According to such a configuration, the unique identifier and the simulated identifier are continuous. This facilitates the designing of the communication system. For example, in the CAN protocol, a high priority is assigned to the message ID having a small value. The simulated identifier is continuous with the unique identifier so that the priority of the selected simulated identifier remains the same as the unique identifier. This allows for application while maintaining the priority by the CAN protocol.

### BRIEF DESCRIPTION OF THE DRAWINGS

FIG. 1 is a schematic block diagram of a vehicle including a communication system according to one embodiment of the present invention.

FIG. 2 is a schematic block diagram of the communication system shown in FIG. 1.

FIG. 3 is a schematic block diagram of a transmission processor shown in FIG. 2.

FIG. 4 is a block diagram showing a schematic configuration of a reception processor shown in FIG. 2.

FIG. 5 is a diagram of a communication subject message ID list shown in FIGS. 3 and 4.

FIG. 6 is a diagram of a conversion subject message ID list shown in FIGS. 3 and 4.

FIG. 7 is a diagram of a conversion count value list shown in FIGS. 3 and 4.

FIG. 8 is a flowchart showing the procedures for initializing the conversion count list in the communication system shown in FIG. 1.

FIG. 9 is a flowchart showing the procedures for processing the communication message transmitted by the transmission processor shown in FIG. 2.

FIG. 10 is a flowchart showing the procedures for processing a communication message received by the reception processor shown in FIG. 2.

FIG. 11 is a diagram of a set candidate message ID list of a message ID that can be assigned as a converting destination in the communication system according to the embodiment of the present invention.

FIG. 12 is a diagram of a conversion subject message ID list based on the message ID registered in the candidate message ID list shown in FIG. 11.

FIG. 13 is a schematic block diagram of an ECU used in the communication system according to the embodiment of the present invention.

FIG. 14 is a schematic block diagram of an ECU used in the communication system according to a further embodiment of the present invention.

### MODES FOR CARRYING OUT THE INVENTION

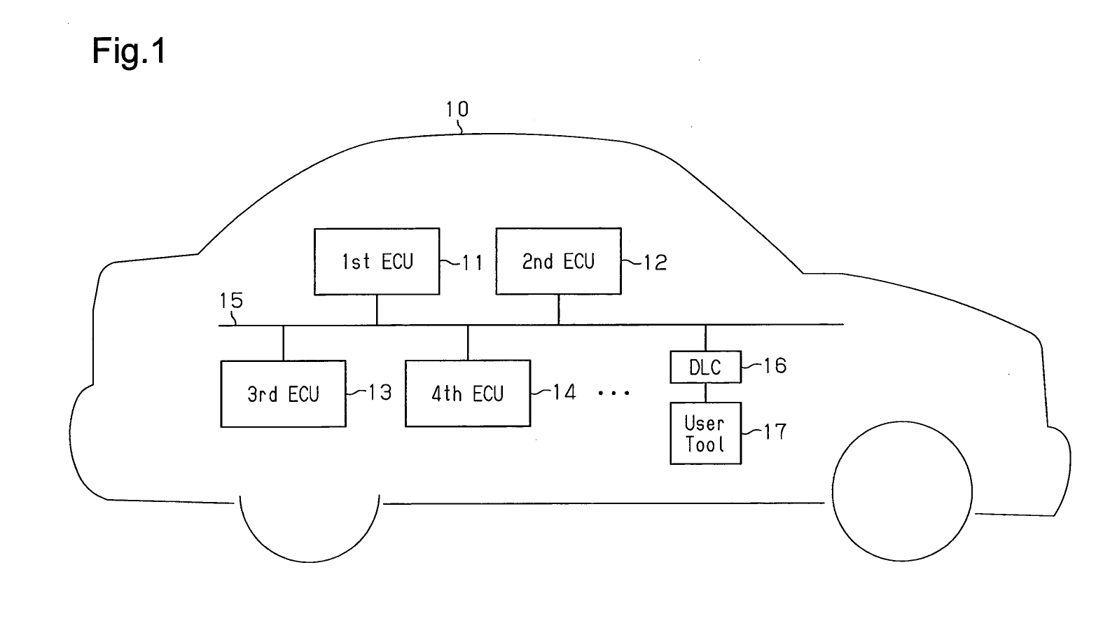

A communication system according to a first embodiment of the present invention will now be described with reference to FIGS. 1 to 10.

As shown in FIG. 1, a vehicle 10 includes an in-vehicle network system serving as a communication system. The in-vehicle network system includes first to fourth electronic control units (ECU) 11 to 14 serving as communication apparatuses, and a communication bus 15 to which the first to fourth ECUs 11 to 14 are connected. The first to fourth ECUs 11 to 14 are thus able to exchange (transmit and receive) various types of information used for control or the like with one another through the communication bus 15. The in-vehicle network system is configured as a CAN network to which the CAN (Controller Area Network) protocol is applied as the communication protocol. The communication bus 15 is, for example, a twist pair cable. A further ECU can thus be easily added to the communication bus 15 so that the added ECU can easily transmit and receive the communication message.

Furthermore, a data link connector (DLC) 16, which is a connection terminal capable of communicably connecting an external device, is arranged on the communication bus 15. The DLC 16 communicably connects a diagnosis device or the like serving as a normal communication apparatus prepared by manufacturers, car dealers, and the like to the communication bus 15. Furthermore, the DLC 16 can also connect a user tool 17, which is a non-normal communication apparatus uniquely prepared by the user.

Thus, if another ECU, the user tool 17, or the like, of which operation verification when connected to the network is insufficient, is connected to the communication bus 15, the communication message transmitted from such devices may adversely affect the communication in the communication bus 15. Especially, when an inappropriate software, virus, and the like is executed, the user tool 17 such as a non-normal tester, a smartphone, and the like may cause a transmission operation and the like of the communication message that adversely affects communication in the communication bus 15. Furthermore, an unauthorized ECU may be connected to the communication bus 15 to interfere communication. Thus, the communication system needs to prevent communication of a communication message that may affect communication in the communication bus 15.

Each of the first to fourth ECUs 11 to 114 is a control unit used for various types of controls of the vehicle 10, and is an ECU of which control subject is, for example, a drive system, a travel system, a vehicle body system, an information device system, or the like. For instance, an ECU of which the control subject is the drive system may be an engine ECU, an ECU of which the control subject is the travel system may be a steering ECU and a brake ECU, an ECU of which the control subject is the vehicle body system may be a light ECU and a window ECU, and an ECU of which the control subject is the information device system may be a car navigation ECU. The number of ECUs connected to the communication bus 15 is not limited to four, and may be three or less, or five or more. The first to fourth ECUs 11 to 14 have similar structures, and hence only the structure of the first ECU 11 will be described below, and the second to fourth ECUs 12 to 14 will not be described.

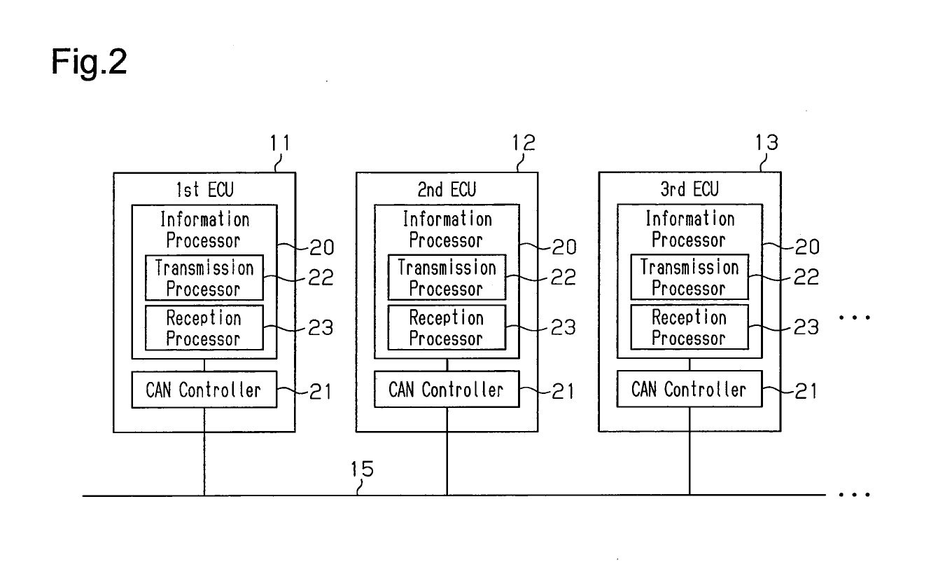

As shown in FIG. 2, the first ECU 11 includes an information processor 20 that carries out processes necessary for the various types of controls using the various types of information, and a CAN controller 21 that carries out communication with a communication message based on the CAN protocol with another ECU through the communication bus 15 and that exchanges data associated with the communication message with the information processor 20.

The CAN controller 21 analyses the communication message received from the communication bus 15, acquires a message ID, communication data, which is a data main body to be transferred, and the like included in the communication message, and provides the acquired message ID, the communication data, and the like to the information processor 20. The CAN controller 21 also generates a communication message including a message ID, communication data, and the like based on the message ID, the communication data, and the like input from the information processor 20, and transmits the generated communication message to the communication bus 15.

Therefore, in the first ECU 11, the communication message transmitted (sent) through the communication bus 15 is received by the CAN controller 21, and the associated data such as the communication data included in the received communication message is acquired from the CAN controller 21 to the information processor 20. Furthermore, in the first ECU 11, the communication data, and the like that is to be transmitted is provided from the information processor 20 to the CAN controller 21, and the communication message including the provided communication data, and the like is transmitted (sent) from the CAN controller 21 to the communication bus 15.

The information processor 20 of the first ECU 11 can thus acquire various types of data necessary for the control function transmitted from the second to fourth ECUs 12 to 14 from the communication message flowing through the communication bus 15. The various types of data to be transmitted to the second to fourth ECUs 12 to 14 and the like can be included in the communication message and transmitted to the communication bus 15.

The information processor 20, which is configured to include a microcomputer, includes a computation device, which performs various types of processing, and a storage device, which holds the computation result, a program that provides various types of control functions, and the like. In the information processor 20, when the program providing a predetermined control function is processed in the computation device, the predetermined control function is provided. In the present embodiment, the information processor 20 includes a transmission processor 22, which carries out a conversion process (replacement process) on the message ID included in the communication message that is to be transmitted, and a reception processor 23, which carries out a reconversion process (re-replacement process) on the message ID included in the received communication message. The transmission processor 22 and the reception processor 23 exhibit the functions when a corresponding program held in the storage device is executed by the computation device.

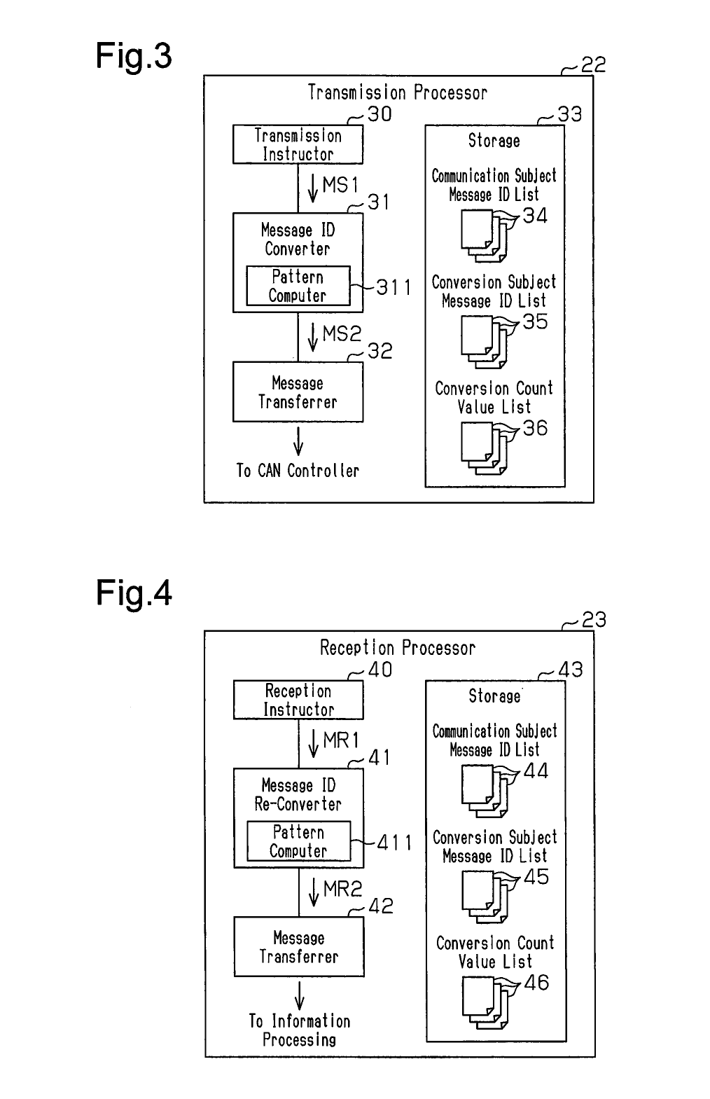

As shown in FIG. 3, the transmission processor 22 includes a transmission instructor 30, to which the message ID and the communication data are input as message data from the information processor 20, and a message ID converter 31 that performs a conversion process on the message data input to the transmission instructor 30. The transmission processor 22 also includes a message transferrer 32 that outputs the message data performed with the conversion process by the message ID converter 31 to the CAN controller 21, and a storage 33 that holds various types of data used in the conversion process on the message data. In the present embodiment, the storage device of the information processor 20 is used as the storage 33, but the storage device used for the storage 33 may be another storage device. The storage 33 includes a communication subject message ID list 34, a conversion subject message ID list 35, and a conversion count value list 36.

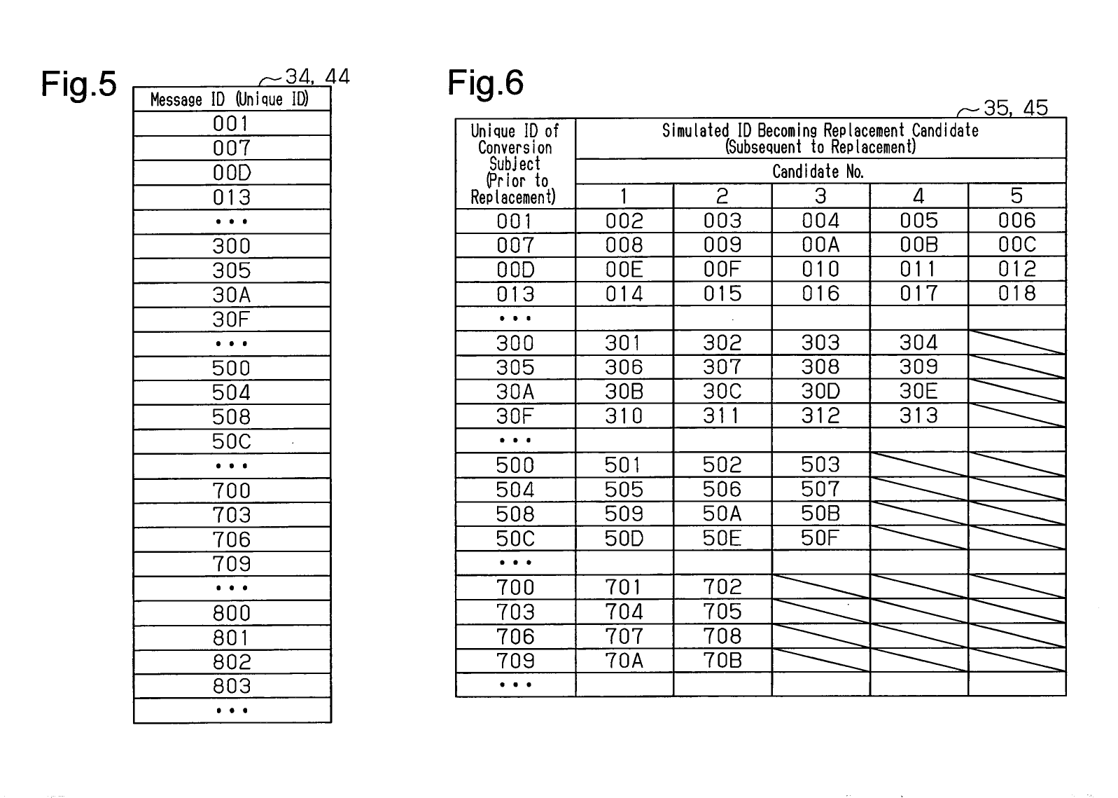

As shown in FIG. 5, a plurality of message IDs is set in the communication subject message ID list 34. The message ID is an ID defined based on a specification of the CAN protocol, and one ID is defined for each content of the communication data included in the communication message. That is, only one message ID is set in correspondence with the content of the communication data in the communication subject message ID list 34 so that the content of the communication data can be identified by the message ID. In the present embodiment, the message ID, only one of which is set in correspondence with the content of the communication data, is referred to as the “unique ID” (unique identifier) for the sake of brevity. In other words, in communication under the CAN protocol, the communication message is usually transmitted and received and the content of the communication data included in the communication message is identified based on the unique ID (message ID) given to the communication message. For example, in the communication subject message ID list 34, “001”, “007”, “00D”, “013”, . . . , “300”, “305”, “30A”, “30F”, . . . , “500”, “504”, “508”, “50C” are set as the unique ID for the communication subject message ID. Furthermore, in the communication subject message ID list 34, “700”, “703”, “706”, “709”, . . . , “800”, “801”, “802”, “803”, . . . and the like are set as the unique ID for the communication subject message ID. For instance, the unique ID and the content of the communication data are corresponded such as the content of the communication data having the unique ID “001” is associated with a brake operation amount, the content of the communication data having the unique ID “007” is associated with an accelerator operation amount, the content of the communication data having the unique ID “00D” is associated with speed, and the content of the communication data having the unique ID “013” is associated with acceleration, and the like.

As shown in FIG. 6, in the conversion subject message ID list 35, a unique ID assumed as the replacement subject (replacement source) of the unique IDs set in the communication subject message ID list 34 is set, and one or a plurality of simulated IDs (simulated identifier), which is a replacement candidate (replacement destination) that can replace (convert) the unique ID is set. In other words, the simulated ID is an ID having a format similar to the message ID, and is an ID replaceable from the unique ID. The simulated ID is associated with the unique ID, but there is no need for only one simulated ID to be set for the content of the communication data. For example, in the conversion subject message ID list 35, “001”, “007”, “00D”, “013”, . . . , “300”, “305”, “30A”, “30F”, are set as the unique ID that is to be converted (replacement source) for the conversion subject message ID. Furthermore, in the conversion subject message ID list 35, “500”, “504”, “508”, “50C”, . . . , “700”, “703”, “706”, “709”, . . . and the like are set as the unique ID that is to be converted.

In the conversion subject message ID list 35, five simulated IDs, having candidate numbers 1 to 5 that become the replacement candidate (replacement destination) corresponding to the unique ID “001” are set as the IDs continuing the unique ID. In this case, the simulated ID having the candidate number 1 is “002”, the simulated ID having the candidate number 2 is “003”, the simulated ID having the candidate number 3 is “004”, the simulated ID having the candidate number 4 is “005”, and the simulated ID having the candidate number 5 is “006”. For example, if the brake operation amount is assigned to the unique ID “001”, the brake operation amount is usually communicated only by the communication message given the unique ID “001”, but in the present embodiment, any one of the simulated IDs “002” to “006” may be given to the communication message of the brake operation amount. Similarly, four simulated IDS, having the candidate numbers 1 to 4, that is, “301”, “302”, “303”, and “304” that become the replacement candidate are set for the unique ID “300”. Three simulated IDs, having the candidate numbers 1 to 3, that is, “501”, “502”, and “503” that become the replacement candidate are set for the unique ID “500”, and two simulated IDs, that is, “701” and “702” having the candidate numbers 1 and 2 that become the replacement candidate are set for the unique ID “700”. For the sake of brevity, the simulated ID that becomes the replacement candidate (replacement destination) set for the other unique IDs (replacement source) in the conversion subject message ID list 35 of FIG. 6 will not be described.

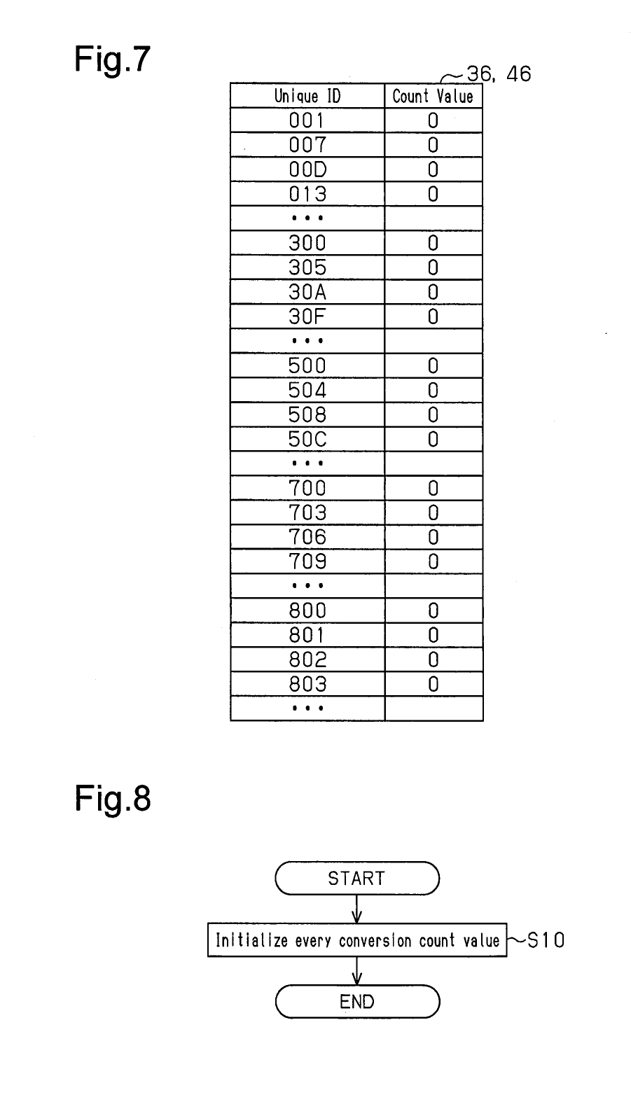

As shown in FIG. 7, the conversion count value list 36 records the number of transmissions/receptions of the communication message for each unique ID as a count value. In the conversion count value list 36, when the communication message is transmitted, one is added to a counter value of the unique ID corresponding to the communication message and one is added to a counter value of the unique ID corresponding to the received communication message. When transmitting the communication message, the information processor 20 updates the count value according to the transmission, and thus when receiving the communication message it transmitted, the count value involved in the reception is not updated.

In the CAN protocol, all the ECUs connected to the communication bus 15 can receive the communication message flowing through the communication bus 15. Thus, when the information processor 20 updates the count value corresponding to the unique ID based on the communication message that is transmitted or received, the count values of the unique ID set in the conversion count value list 36 of the respective ECU are synchronized (in conformance) in the ECUs connected to the communication bus 15.

As shown in FIG. 3, the message ID converter 31 carries out the conversion process (replacement process) on the unique ID included in the message data MS1 input from the transmission instructor 30. For example, if the unique ID included in the message data MS1 is not set in the conversion subject message ID list 35, the message ID converter 31 does not convert (replace) the unique ID. If the unique ID included in the message data MS1 is set in the conversion subject message ID list 35, the message ID converter 31 converts (replaces) the unique ID with one simulated ID selected from the plurality of simulated IDs that become the replacement candidates of the unique ID. The simulated ID is selected by applying the computation result from a pattern computer 311 of the message ID converter 31 to the candidate number of the conversion subject message ID list 35. Message data MS2 obtained by the conversion process is output to the message transferrer 32.

The pattern computer 311 generates and outputs a pattern (random pattern) by a pseudo random number, which estimation from the outside is not easy, according to an input parameter. That is, the pattern computer 311 has a pattern (order) such that different values are generated for each parameter, and the pattern (order) advances with change in the parameter. Thus, in the pattern computer 311, the output based on the random pattern is updated by the condition of changing the input parameter. If an output range is set, the pattern computer 311 outputs the value of the set output range as a computation result. For example, if an integer output range is set, the pattern computer 311 calculates the pseudo random number that is an integer, and obtains the remainder when dividing the calculated integer by the value of the output range. The pattern computer 311 thereby calculates a value of a type (integer) equal to the value of the “output range” from “0” to “output range −1”. As long as the required output result can be obtained from the pattern computer 311, the computation process in the pattern computer 311 is not limited to the above method, and other known methods may be used.

As shown in FIG. 4, the reception processor 23 includes a reception instructor 40 that acquires the message data from the CAN controller 21, and a message ID re-converter 41 that performs a conversion process on the message data input from the reception instructor 40. The reception processor 23 also includes a message transferrer 42 that outputs the message data performed with the conversion process by the message ID re-converter 41 to the information processor 20, and a storage 43 that holds various types of data used in the conversion process on the message data. In the present embodiment, the storage device of the information processor 20 is used for the storage 43, but the storage device used for the storage 43 may be other storage devices.

The storage 43 includes a communication subject message ID list 44, a conversion subject message ID list 45, and a conversion count value list 46. The communication subject message ID list 44 is the same as the communication subject message ID list 34 shown in FIG. 5, and the conversion subject message ID list 45 is the same as the conversion subject message ID list 35 shown in FIG. 6 and thus will not be described. The communication subject message ID list 34 may be used for the communication subject message ID list 44, and the conversion subject message ID list 35 may be used for the conversion subject message ID list 45. The conversion count value list 46 commonly uses or is set to synchronize (coincide) with the conversion count value list 36 shown in FIG. 7 and thus will not be described.

The message ID re-converter 41 carries out the conversion process (re-replacement process) on the message ID (unique ID or simulated ID) included in the message data MR1 input from the CAN controller 21. For example, if the message ID is set in the communication subject message ID list 44, the message ID re-converter 41 converts (replaces) the message ID since the message ID is a unique ID. If the message ID is not set in the communication subject message ID list 44 but is set in the conversion subject message ID list 45, the message ID re-converter 41 reconverts (re-replaces) the simulated ID with the unique ID of before the conversion (before the replacement) since the message ID is the simulated ID. The re-replacement to the unique ID of before the replacement is carried out by applying the computation result from a pattern computer 411 to the candidate number of the conversion subject message ID list 45. The message data MR2 obtained by the conversion process is output to the message transferrer 42.

The pattern computer 411 has the same configuration as the pattern computer 311 of the transmission instructor 30 and thus will not be described. The pattern computer 311 may be commonly used for the pattern computer 411.

The operation of the communication system of the present embodiment will now be described with reference to FIGS. 8 to 10.

First, initialization of the communication system will be described. The initialization of the communication system is executed when an initialization condition of the communication system is met such as when an ignition switch of the vehicle 10 is turned ON and the like. The initialization condition of the communication system includes activation of the communication system, instruction from the ECU monitoring the communication system, operation by a driver, and the like.

As shown in FIG. 8, when the initialization of the communication system is started, the count value of the conversion count value list 36 in each ECU is initialized, for example, set to “0” in all of the ECUs, for example, the first to fourth ECUs 11 to 14 connected to the communication bus 15 (step S10 of FIG. 8). Such initialization is carried out at a similar timing in all of the ECUs but the timing may be separately measured by each ECU or instructed by a communication message instructing initialization and transmitted from one ECU.

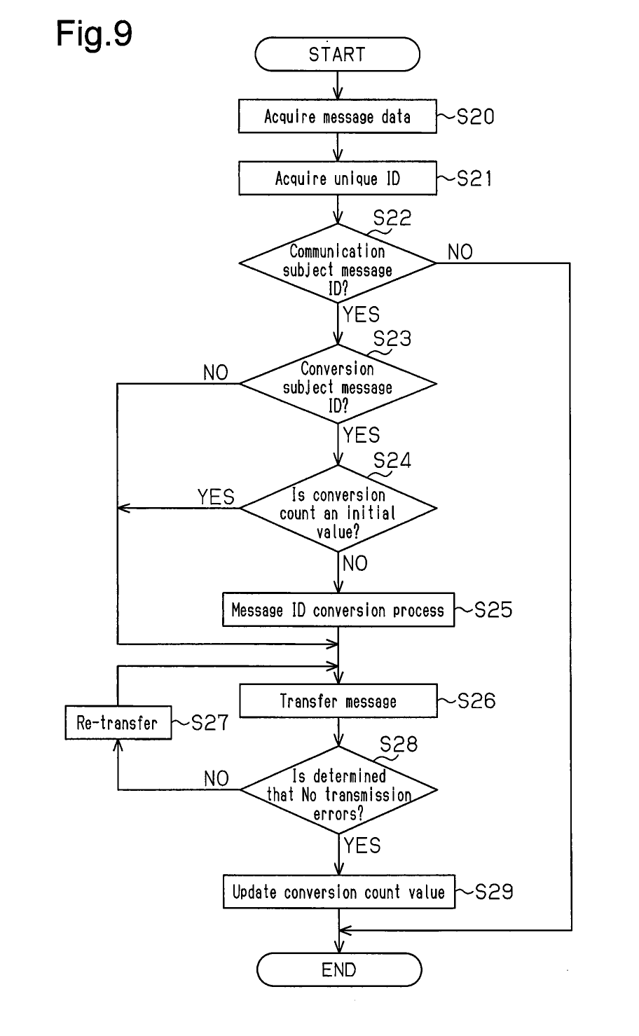

A case of when the communication message is transmitted will now be described with reference to FIG. 9.

Whenever preparing the communication data that is transmitted, the information processor 20 prepares the message data including the communication data and the unique ID corresponding to the communication data and starts the transmission process on the message data.

As shown in FIG. 9, when the transmission process is started, the transmission processor 22 acquires the message data prepared by the information processor 20 (step S20 of FIG. 9), and acquires the unique ID included in the message data (step S21 of FIG. 9). The transmission processor 22 also refers to the communication subject message ID list 34 to determine whether or not the acquired unique ID is the message ID that is to be communicated (step S22 of FIG. 9). When determining that the acquired unique ID is not the communication subject message ID (NO in step S22 of FIG. 9), the transmission processor 22 cancels the transmission process of the communication message based on the acquired message data, and does not transmit the communication message corresponding to the unique ID.

When determining that the acquired unique ID is the communication subject message (YES in step S22 of FIG. 9), the transmission processor 22 refers to the conversion subject message ID list 35 to determine whether or not the unique ID is the conversion subject message ID (step S23 of FIG. 9). When determining that the unique ID is the conversion subject message ID (YES in step S23 of FIG. 9), the transmission processor 22 refers to the conversion count value list 36 to determine whether or not the count value corresponding to the unique ID is an initial value (step S24 of FIG. 9). When determining that the count value corresponding to the unique ID is not the initial value (NO in step S24 of FIG. 9), the transmission processor 22 carries out a message ID conversion process of replacing the unique ID with the simulated ID (step S25 of FIG. 9).

When determining that the unique ID is not the conversion subject message ID (NO in step S23 of FIG. 9), and when determining that the count value corresponding to the unique ID is the initial value (YES in step S24 of FIG. 9), the transmission processor 22 does not execute the message ID conversion process of step S25 and carries out a message transferring process (YES in step S26 of FIG. 9).

In the message ID conversion process, the transmission processor 22 inputs the number of simulated IDs assumed as the replacement candidates for the unique ID to the pattern computer 311 as the output range, and inputs the count value corresponding to the unique ID to the pattern computer 311 as a parameter. In the present embodiment, the count value corresponding to the unique ID corresponds to the selecting condition for selecting the simulated ID, and the pseudo random number computed by the pattern computer 311 corresponds to the pattern. The integer corresponding to the output range is thus obtained from the pattern computer 311, where the transmission processor 22 uses a number, in which “1” is added to the obtained integer, as a candidate number to select one simulated ID from the simulated IDs, which are assumed as the replacement candidates to the unique ID.

For example, as shown in FIG. 6, when the unique ID is “001”, there are “five” simulated IDs that become the replacement candidates, “002”, “003”, “004”, “005”, and “006”. In this case, the count value obtained from the variable count value list is input as the parameter and the number “5” of the simulated IDs is input as the output range to the pattern computer 311, whereby any one of the integers from “0” to “4” is obtained in a random pattern as a computation result from the pattern computer 311. The transmission processor 22 assumes a value obtained by adding “1” to the computation result of the pattern computer 311 as a candidate number. That is, in the transmission processor 22, the simulated ID “002” of the candidate number “1” is selected based on the computation result “0”, the simulated ID “003” of the candidate number “2” is selected based on the computation result “1”, and the simulated ID “004” of the candidate number “3” is selected based on the computation result “2”. Furthermore, the simulated ID “005” of the candidate number “4” is selected based on the computation result “3”, and the simulated ID “006” of the candidate number “5” is selected based on the computation result “4”.

Thus, in each ECU including the pattern computer 311, if for one simulated ID that is to be selected as the replacement candidate of the unique ID, all conditions of the number of simulated IDs that become the replacement candidates, the value of each simulated ID, the pattern adopted by the pattern computer 311, and the count value corresponding to the unique ID match, the same ID is appropriately selected. In other words, if any one of the above conditions does not match, one simulated ID that becomes the conversion candidate of the unique ID cannot be appropriately selected, and hence a simulated ID different from another ECU is selected in the ECU.

The transmission processor 22 of the first ECU 11 replaces the unique ID with the simulated ID selected based on the computation result of the pattern computer 311 obtained in the above manner.

After the unique ID of the message data is converted to the simulated ID, when determined as NO in step S23, or when determined as YES in step S24, the transmission processor 22 carries out a message transfer (step S26 of FIG. 9). In the message transfer, the transmission processor 22 outputs the message ID (unique ID or simulated ID) and the communication data included in the message data to the CAN controller 21, and the CAN controller 21 generates a communication message based on the message data received from the transmission processor 22 and transmits the same to the communication bus 15. Thus, if the message ID is the simulated ID, the simulated ID is used as the message ID of the communication message, and thus the reliability of the communication message is improved. If the message ID remains as the unique ID, the unique ID is used as the message ID of the communication message, and the usual communication in the CAN protocol can be carried out.

After the message transfer, the transmission processor 22 monitors the CAN controller 21 and checks whether or not a transmission error occurred in the transmission process of the communication message (step S28 of FIG. 9). When determining that a transmission error occurred in the transmission process of the communication message (NO in step S28 of FIG. 9), the transmission processor 22 prepares the same message data as the previous message transfer (step S27 of FIG. 9) and returns to step S26 to execute message transfer and the subsequent processes again.

When determining that the transmission error did not occur in the transmission process of the communication message (YES in step S28 of FIG. 9), the transmission processor 22 adds 1 to the count value corresponding to the unique ID to update the count value (step S29 of FIG. 9). The transmission process of the communication message is then terminated. By updating the count value in such manner, the simulated ID can be changed, that is, the communication message in which the message ID changes in real time can be transmitted each time the message ID conversion process is executed.

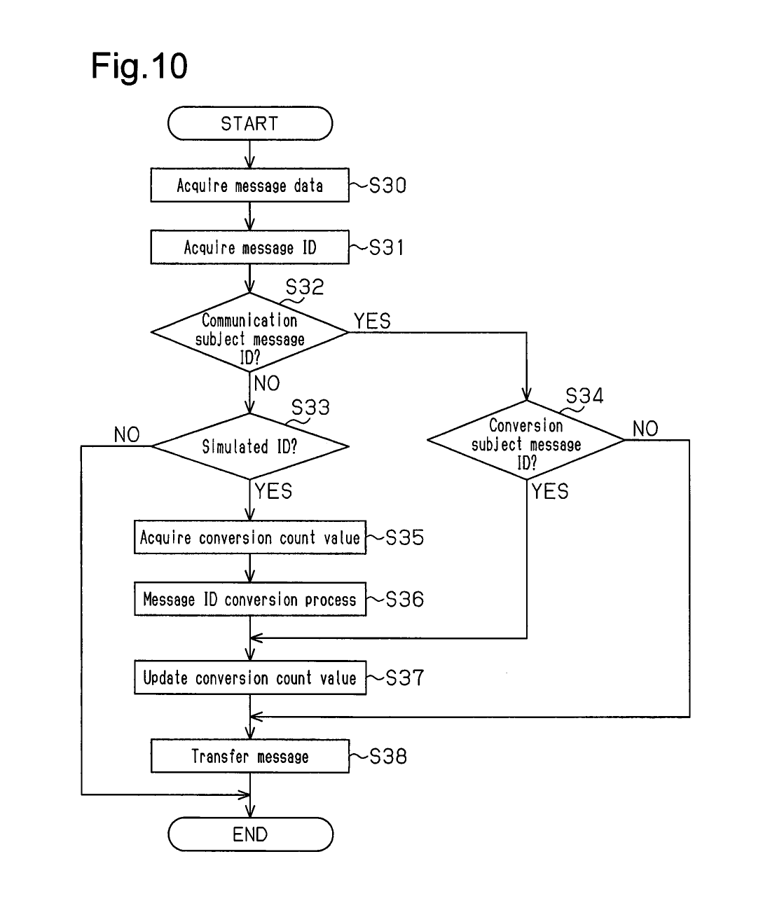

A case in which the communication message is received will now be described with reference to FIG. 10.

In the information processor 20, the CAN controller 21 analyzes the communication message from the communication bus 15 and outputs the message data to start the reception process.

As shown in FIG. 10, when the reception process is started, the reception processor 23 acquires the message data output from the CAN controller 21 (step S30 of FIG. 10) and acquires the message ID (unique ID or simulated ID) included in the message data (step S31 of FIG. 10). After acquiring the message ID, the reception processor 23 refers to the communication subject message ID list 44 to determine whether or not the acquired message ID is the unique ID (step S32 of FIG. 10). If the message ID is the unique ID (YES in step S32 of FIG. 10), the reception processor 23 refers to the conversion subject message ID list 45 to determine whether or not the unique ID is the conversion subject message ID (replacement source) (step S34 of FIG. 10).

If the unique ID is not the conversion subject message ID (replacement source) (NO in step S34 of FIG. 10), the reception processor 23 transfers the message data to the information processor 20 as is (step S38 of FIG. 10). That is, it is apparent that the communication message is the message communicated by the unique ID, and that the simulated ID that becomes the replacement candidate is not set for the unique ID.

If the unique ID is the conversion subject message ID (replacement source) (YES in step S34 of FIG. 10), the reception processor 23 updates the conversion count value corresponding to the unique ID (step S37 of FIG. 10) and transfers the message data to the information processor 20 as is (step S38 of FIG. 10). That is, it is apparent that the communication message is the message communicated by the unique ID, and that the simulated ID that becomes the replacement candidate is set for the unique ID. Thus, even for the unique ID set with the simulated ID that becomes the replacement candidate, if the corresponding count value is an initial value as shown in step S24 of FIG. 9, the unique ID is not converted to the simulated ID and thus the communication message having the message ID as the unique ID is transmitted.

If the message ID is not the communication subject message ID (unique ID) (NO in step S32 of FIG. 10), the message ID has a possibility of being the simulated ID. The reception processor 23 then determines whether or not the message ID is included in the simulated ID assumed as the conversion candidate from the unique ID (step S33 of FIG. 10). When determining that the message ID is not included in the simulated ID assumed as the conversion candidate (NO in step S33 of FIG. 10), the reception processor 23 determines that the message ID is not the unique ID or the simulated ID and terminates the reception process of the communication message. That is, the message ID is determined as an ID that is not used in the communication system.

When determining that the message ID is included in the simulated ID assumed as the conversion candidate from the unique ID (YES in step S33 of FIG. 10), the reception processor 23 determines that the message ID is the simulated ID. The reception processor 23 acquires the unique ID corresponding to the message ID (simulated ID), and acquires the number of simulated IDs assumed as the conversion candidate from the unique ID and the count value corresponding to the unique ID (step S35 of FIG. 10). When the count value is input as a parameter and the number of simulated IDs assumed as the replacement candidates from the unique ID is input as an output range to the pattern computer 411, any one of an integer from “0” to “number of simulated IDs−1” is obtained in a random pattern as the computation result from the pattern computer 411. A value obtained by adding “1” to the computation result obtained in the above manner is applied to the conversion subject message ID list 45 as a candidate number, whereby one simulated ID selected from the simulated IDs assumed as the replacement candidate from the unique ID is acquired. If the one simulated ID acquired in the above manner and the simulated ID acquired from the communication message match, the simulated ID is determined as an appropriate ID corresponding to the unique ID and thus the simulated ID is re-replaced with the unique ID. In other words, the message ID of the message data becomes the unique ID re-replaced from the simulated ID (step S36 of FIG. 10).

After the simulated ID of the message data is re-replaced with the unique ID, the reception processor 23 updates the conversion count value corresponding to the unique ID (step S37 of FIG. 10) and transfers the message data to the information processor 20 (step S38 of FIG. 10). The reception process with respect to the message data is then terminated.

The information processor 20 identifies the content of the communication data included in the message data based on the unique ID included in the message data of after the reception process is performed, and carries out an appropriate process on the communication data. That is, even when receiving the communication message in which the message ID changes in real time, the information processor 20 can obtain an appropriate unique ID in correspondence with the message ID (simulated ID) that changes in real time by updating the count value and can receive the communication message in which the message ID changes in real time.

Thus, in the communication system, the difficulty to read the content of the communication data in the communication message increases. Thus, the communication by an unauthorized communication message caused by an unauthorized communication apparatus connected to the communication bus 15 is prevented, and the reliability of the communication message is improved.

As described above, the communication system according to the present embodiment has that advantages listed below.

(1) The unique ID used for the identification of the communication message is replaced by the simulated ID in the communication with another ECU, and the communication message is transmitted and received by the simulated ID after the replacement.

Thus, if the communication of the communication message is carried out based on the simulated ID, even if the unique ID is acquired in an unauthorized or inadvertent manner, communication of the unauthorized communication message based on the unique ID is prevented. In other words, the reliability of the communication message communicated by the communication system is improved.

The simulated ID that replaces the unique ID is selected based on a random pattern. The simulated ID used for the communication is thus changed based on the random pattern. Thus, even if the unique ID or the simulated ID is acquired in an unauthorized or inadvertent manner, communication of an unauthorized communication message is prevented by switching the simulated ID used for the communication. Furthermore, the change in the selection of the replacement subject by the random pattern is difficult to recognize even when monitoring the communication message. Thus, even if the simulated ID is acquired, communication of an unauthorized device is prevented since the assumption of the pattern (order) for selecting the simulated ID appropriate for the communication is difficult.

(2) The number of simulated IDs that become the replacement candidates increases as the unique ID becomes smaller. This increases the reliability of the communication message with a small message ID, which has a higher priority in the CAN protocol. Thus, an appropriate reliability corresponding to the priority level is set for the communication message.

(3) An appropriate simulated ID is selected, that is, updated for each communication using the simulated ID. Thus, an unauthorized communication message becomes difficult to communicate using the appropriate simulated ID, and the reliability of the communication message remains high.

(4) The replacement subject is selected by the random pattern, and thus it is difficult to appropriately assume the simulated ID that is to be selected even if the communication message is being monitored. Thus, unauthorized communication using the simulated ID becomes difficult, and the reliability of the communication message remains high.

(5) The selection of the simulated ID of the replacement subject is synchronized among the plurality of ECUs. Thus, the selecting subject is easily and reliably selected in each communication, and the reliability of the communication message remains high.

(6) The simulated ID is changed in real time so that the reliability of the communication message based on the CAN protocol remains high. The ECU that receives the communication message under the CAN protocol usually processes the message if the message ID given to the communication message is correct. However, this configuration sets the message ID as the simulated ID and increases the reliability of the communication message.

(7) Among the IDs defined as the unique ID, for example, non-assigned (vacant) IDs or IDs of which the usage condition is limited during, for example, tests or the like are used. Thus, the communication system that improves the reliability of the communication message may easily be applied to an existing system.

(8) The plurality of IDs continuous with the unique IDs are set as the plurality of simulated IDs. Since the unique ID and the simulated ID are continuous, the design of the communication system is facilitated. For example, in the CAN protocol, high priority is assigned to the message ID having a small value. The simulated ID is continuous with the unique ID so that the priority of the selected simulated ID is maintained. This allows for application while maintaining the priority with the CAN protocol.

### Other Embodiments

The above embodiment may be modified as described below.

In the embodiment described above, the information processor 20 includes the transmission processor 22 and the reception processor 23. However, the location of the transmission processor and the reception processor is not limited as long as data can be exchanged with the information processor and with the CAN controller.

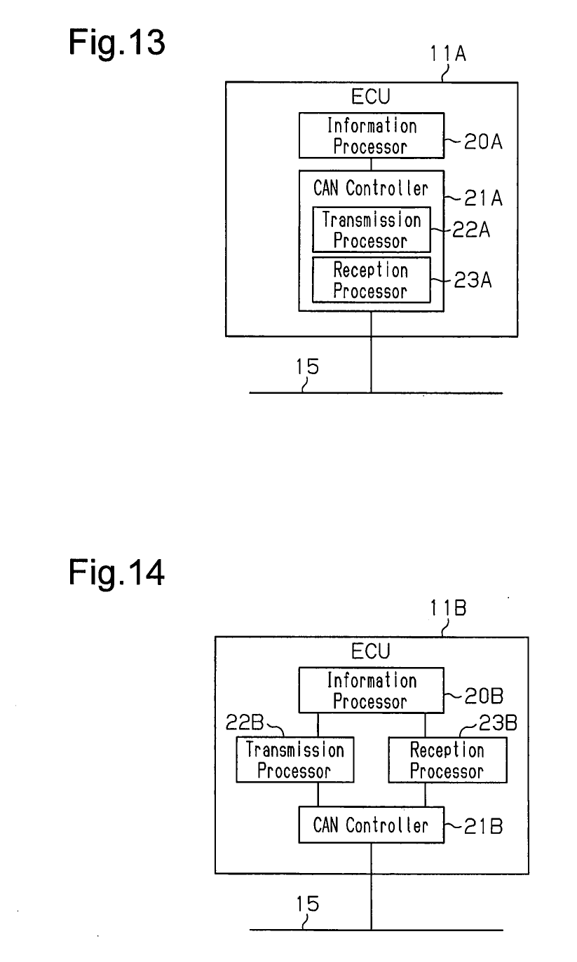

For example, as shown in FIG. 13, in an ECU 11A including an information processor 20A and a CAN controller 21A, a transmission processor 22A and a reception processor 23A may be arranged in the CAN controller 21A.

Furthermore, for example, as shown in FIG. 14, in an ECU 11B including an information processor 20B and a CAN controller 21B, a transmission processor 22B and a reception processor 23B may be arranged between the CAN controller 21B and the information processor 20B.

This increases the degree of design freedom for the communication system.

In the embodiment described above, an ID continuous with a unique ID is used as a simulated ID that becomes a replacement candidate from the unique ID. However, the simulated ID that becomes the replacement candidate from the unique ID does not have to be continuous with the unique ID. Simulated IDs do not have to be continuous IDs. This increases the degree of design freedom for the communication system and increases the applicability allowing for application to an existing system.

In the embodiment described above, the simulated ID is selected from the IDs that do not correspond to the content of the communication data. However, the simulated ID may be an ID corresponding to the content of the communication data or an ID that is not used when the vehicle 10 travels such as a test ID. This increases the degree of design freedom for the communication system and increases the applicability allowing for application to an existing system.

In the embodiment described above, a simulated ID that becomes the replacement candidate of the unique ID is set in advance in the conversion subject message ID list 35. However, the simulated ID that becomes the replacement candidate of the unique ID may be set in accordance with the assignment situation of the unique ID in the communication system.

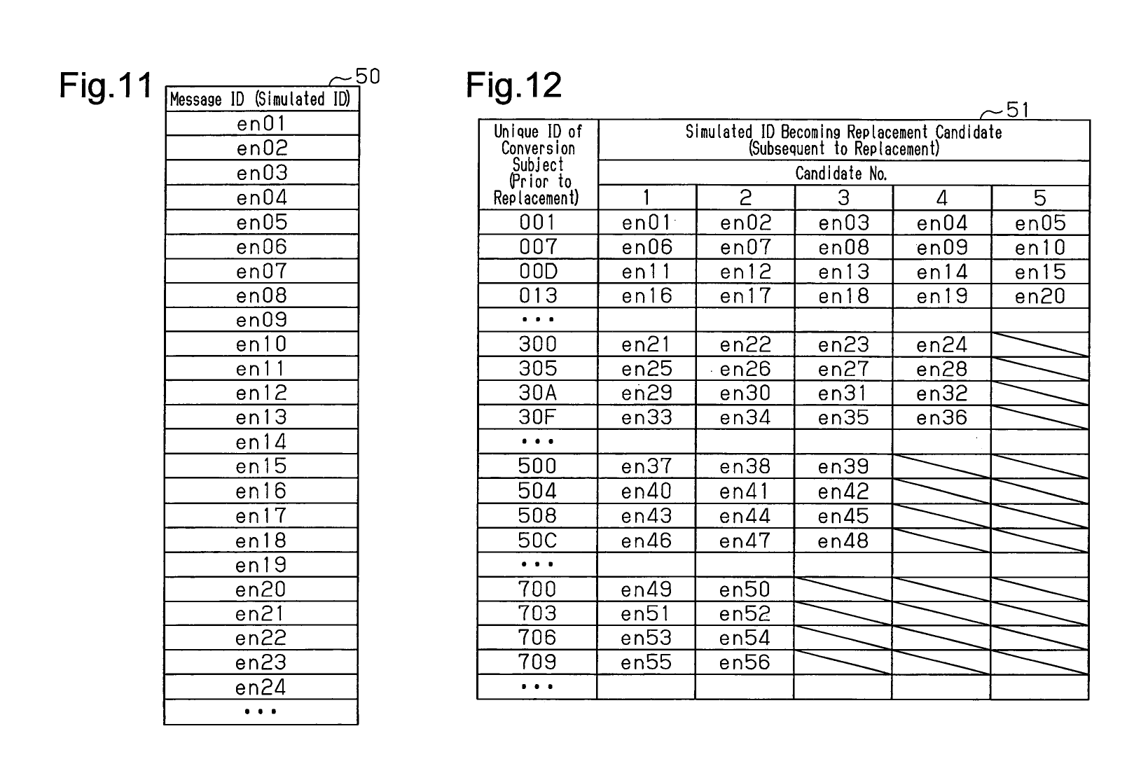

For example, an ID other than the unique ID used when travelling may be set in a usable ID list 50 as a message ID that can be used as the simulated ID, as shown in FIG. 11, and the simulated ID set in the usable ID list 50 may be assigned as the simulated ID that becomes the replacement candidate of the conversion subject message ID list 51, as shown in FIG. 12. Thus, the simulated ID that becomes the replacement candidate can thus be associated with the unique ID in a range in which the message ID can be set so as not to affect the arrangement of the unique ID and the arrangement of the simulated ID. This increases the degree of design freedom of the communication system.

In the embodiment described above, the simulated ID that becomes the replacement candidate from the unique ID is set in the list. However, this is not the sole case, and the simulated ID that becomes the replacement candidate may be obtained through processes such as computation. For example, the simulated ID of unique ID “001” shown in FIG. 6 can also be calculated from an equation “unique ID+computation result of pattern computer+1”. This increases the degree of design freedom of the communication system.

In the embodiment described above, the communication system is a system based on the CAN protocol. However, the communication system can be applied even to a communication protocol in which the plurality of communication apparatuses can start communication at any timing. For example, such a communication protocol includes a series bus system that carries out message addressing and the like. This increases the applicability of the communication system.

In the embodiment described above, the counter value is updated each time the communication with the communication message corresponding to the unique ID is carried out, that is, when the counter value, which is the selecting condition, is synchronized (matched) in all of the ECUs receiving the communication message. However, as long as the synchronization of the counter value, which is the selecting condition, can be synchronized in a plurality of ECUs, the synchronizing may be performed through any process. For example, the synchronization of the counter value may be carried out each time the communication by the communication message corresponding to the unique ID is carried out for a predetermined number of times or may be carried out based on a separately prepared communication message that instructs synchronization. This increases the degree of design freedom for the communication system.

In the embodiment described above, the pattern (order) for selecting the candidate number is a random pattern (pseudo random number). However, the pattern (order) for selecting the candidate number may be an order other than the random pattern such as a numerical order of the candidate number and the like. Even if the selecting order of the simulated ID is determined, the reliability of the communication message is increased as the message ID is changed in real time.

The embodiment described above sets the number of simulated IDs that become the replacement candidate in the output range. However, the value set in the output range may be smaller than the number of simulated IDs that become the replacement candidate. Furthermore, the analysis of the pattern (order) becomes difficult by varying the value to set in the output range. This improves the degree of design freedom for the communication system.

In the embodiment described above, the transmission processor 22 and the reception processor 23 perform processes such as conversion (replacement) and reconversion (re-replacement) on the message ID included in the message data. However, the transmission processor and the reception processor may receive a communication message based on the CAN protocol to analyze the input communication message and perform processes such as conversion (replacement) and reconversion (re-replacement) on the acquired message ID.

The transmission processor and the reception processor may replace the message ID included in the communication message with the message ID obtained by conversion (replacement) and reconversion (re-replacement). Alternatively, the communication data may be acquired by analyzing the communication message, and the message data including the message ID and the communication data obtained through the above process may be generated.

This improves the degree of freedom for the configuration of the communication system.

In the embodiment described above, the unique ID is not included in the replacement candidate. However, the unique ID may be included in the replacement candidate. The number of IDs that become the replacement candidate of the unique ID can thus be increased.

In the embodiment described above, the external device is wire-connected to the DLC 16. However, the external device may be connected to the DLC through wireless communication. For example, a wireless communication terminal may be connected to the DLC and a wireless communication apparatus may be arranged in the external device so that wireless communication is performed between the DLC and the external device. Thus, unauthorized communication can be prevented regardless of the connecting mode of the external device to the DLC.

In the embodiment described above, the communication system is mounted on the vehicle 10. However, part of or all of the communication system may be arranged outside the vehicle. Thus, the determination of whether or not a message is authorized can be made for a communication system formed by a CAN used outside the vehicle. This improves the applicability of the communication system.

In the embodiment described above, the communication system is mounted on the vehicle 10. However, the communication system may be arranged on a moving body other than vehicles, for example, ships, railroads, industrial machines, robots, and the like.

### DESCRIPTION OF REFERENCE CHARACTERS

10 vehicle
11 to 14 first to fourth ECUs (electronic control units)
11A, 11B ECU
15 communication bus
16 data link connector (DLC)
17 user tool
20, 20A, 20B information processor
21, 21A, 21B CAN controller
22, 22A, 22B transmission processor
23, 23A, 23B reception processor
30 transmission instructor
31 message ID converter
311, 411 pattern computer
32, 42 message transferrer
33, 43 storage
34, 44 communication subject message ID list
35, 45, 51 conversion subject message ID list
36, 46 conversion count value list
40 reception instructor
41 message ID re-converter
50 usable ID list

1. A communication system including a plurality of communication apparatuses connected to a communication line, wherein the communication apparatuses are capable of communicating a communication message, the communication system being configured so that:
a unique identifier is added to the communication message to identify the communication message;
the unique identifier, a plurality of simulated identifiers serving as replacement candidates from the unique identifier, and a pattern of a pseudo random number generated based on a number of times the communication message is sent to the communication line apparatus;
a selecting condition for selecting one of the simulated identifiers with the pattern set for each of the communication apparatuses is synchronized for each message;
a communication apparatus that transmits the communication message replaces a unique identifier added to the communication message with a simulated identifier based on the pattern, and transmits the communication message to which the simulated identifier is added after the replacement; and
a communication apparatus receiving the communication message acquires a unique identifier corresponding to a simulated identifier acquired from the received communication message, converts the unique identifier to a simulated identifier based on the pattern set for the communication apparatus, and determines that the acquired simulated identifier is an appropriate simulated identifier when the converted simulated identifier matches the simulated identifier acquired from the received message.

2. The communication system according to claim 1, wherein the number of simulated identifiers set as the replacement candidate from the unique identifier of the communication message is greater in a communication message having a high priority than a communication message having a low priority.

3-4. (canceled)

5. The communication system according to claim 1, wherein the communication apparatuses include a counter that counts the number of times the communication message is sent to the communication line, and the selecting condition of the simulated identifier of the replacement subject based on the pattern is synchronized based on a measured count value of the counter.

6. The communication system according to claim 5, wherein
the communication message is a message of a CAN protocol; and
the unique identifier is a message ID set in the CAN protocol.

7. The communication system according to claim 1, wherein the simulated identifier is selected from unique identifiers that are not added to the communication message.

8. The communication system according to claim 7, wherein a plurality of identifiers that are continuous with the unique identifier are set as the simulated identifiers.

9. A communication method in which a plurality of communication apparatuses communicate a message through a communication line, wherein a communication device that transmits a communication message performs:
adding a unique identifier to the communication message that is transmitted to identify the communication message;
replacing the unique identifier with one of a plurality of simulated identifiers replaceable from the unique identifier using a pseudo random number generated based on a number of times the communication message is sent to the communication line;
synchronizing a selecting condition of the simulated identifier in the communication apparatuses based on the pattern; and
transmitting the communication message after replacing the unique identifier with the simulated identifier;
wherein a communication device that receives a communication message performs:
acquiring a simulated identifier from the received communication message;
replacing the acquired simulated identifier with a unique identifier used to identify the communication message;
synchronizing the replacement in the communication apparatuses based on the pattern;
converting the replaced unique identifier to a simulated identifier based on the pattern;
determining whether the converted simulated identifier matches the simulated identifier acquired from the received message; and
determining that the acquired simulated identifier is an appropriate simulated identifier when the converted simulated identifier matches the simulated identifier acquired from the received message.

10-12. (canceled)
